(19) United States
(12) Patent Application Publication
(10) Pub. No.: US 2017/0103580 A1
(43) Pub. Date: Apr. 13, 2017

(54) METHOD OF MONITORING LOAD CARRIED BY MACHINE

(71) Applicant: Caterpillar Inc., Peoria, IL (US)

(72) Inventors: Peter J. Petrany, Dunlap, IL (US); Douglas J. Husted, Secor, IL (US); Raymond A. Wise, Metamora, IL (US)

(73) Assignee: Caterpillar Inc., Peoria, IL (US)

(21) Appl. No.: 15/387,210

(22) Filed: Dec. 21, 2016

(51) Int. Cl. G06T 19/00; G06T 17/10

(52) U.S. Cl. CPC G06T 19/006; G06T 17/10; G06T 2215/16

(57) ABSTRACT

A method of monitoring a loading status of a machine includes receiving signals indicative of a load carried by a dump body of the machine from a perception sensor and receiving point cloud, derived based on the signals received from the perception sensor, corresponding to a profile of the load from an image processing module. A three dimensional polygonal layout corresponding to the profile of the load is generated based on the signals received from the perception sensor and the point cloud. A fill model image is generated using the generated three dimensional polygonal layout, and the fill model image is further superimposed on a preset image of the dump body of the machine to generate a real time image of the machine. The method further includes monitoring the loading status of the machine based on the generated real time image of the machine.

### TECHNICAL FIELD

The present disclosure relates to monitoring surrounding of a machine disposed at a worksite, and more specifically, to a method of monitoring a loading status of the machine.

### BACKGROUND

Machines, such as off-highway trucks, include a system for monitoring surrounding of the machines disposed at a worksite. The system includes multiple perception sensors, such as cameras, SONAR, and LIDAR, for sensing data associated with the surrounding of the machines. The system further includes a display device for displaying the surrounding of the machines based on the data sensed by the perception sensors. The display device also displays a three dimensional model of the machines in which the system is disposed. However, the three dimensional model of the machines displayed in the display device is a preset image and hence fails to show a real time image associated with a load carried by the dump body of the machines.

U. S. patent publication number US2015/0218781 ('781 patent publication) discloses a display system of an excavating machine having a bucket, and a main body to which the work machine is attached. The display system includes a storage unit to store position information of a design surface. The display system also includes a display unit to display the position information of the design surface on a screen. The display system further includes a processing unit to display an outer edge of a second plane of the design surface. The second plane includes a first plane existing in the design surface. The second plane exists in a part of a periphery of the first plane, on the screen of the display unit, in a different form from inside and outside of the outer edge. The '781 patent publication discloses information related to a design surface of a construction target displayed in the display device, whereas fails to show the real time information associated with the load carried by the dump body of the machines.

### SUMMARY OF THE DISCLOSURE

In an aspect of the present disclosure, a method of monitoring a loading status of a machine disposed at a worksite is provided. The method includes receiving signals indicative of a load carried by a dump body of the machine from a perception sensor. The method further includes receiving point cloud corresponding to a profile of the load carried by the dump body from an image processing module. The point cloud is derived based on the signals received from the perception sensor. The method further includes generating a three dimensional polygonal layout corresponding to the profile of the load carried by the dump body based on the signals received from the perception sensor and the point cloud. The method further includes generating a fill model image using the generated three dimensional polygonal layout and further superimposing the fill model image on a preset image of the dump body of the machine to generate a real time image of the machine. The method further includes monitoring the loading status of the machine based on the generated real time image thereof.

Other features and aspects of this disclosure will be apparent from the following description and the accompanying drawings.

### BRIEF DESCRIPTION OF THE DRAWINGS

FIG. 1 is a perspective view of a machine disposed at a worksite;

FIG. 2 is a block diagram of a system for monitoring a loading status of the machine of FIG. 1;

FIG. 3 is a schematic representation of the loading status of the machine as displayed in a user interface of the machine; and

FIG. 4 is a flowchart of a method of monitoring the loading status of the machine.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claim.

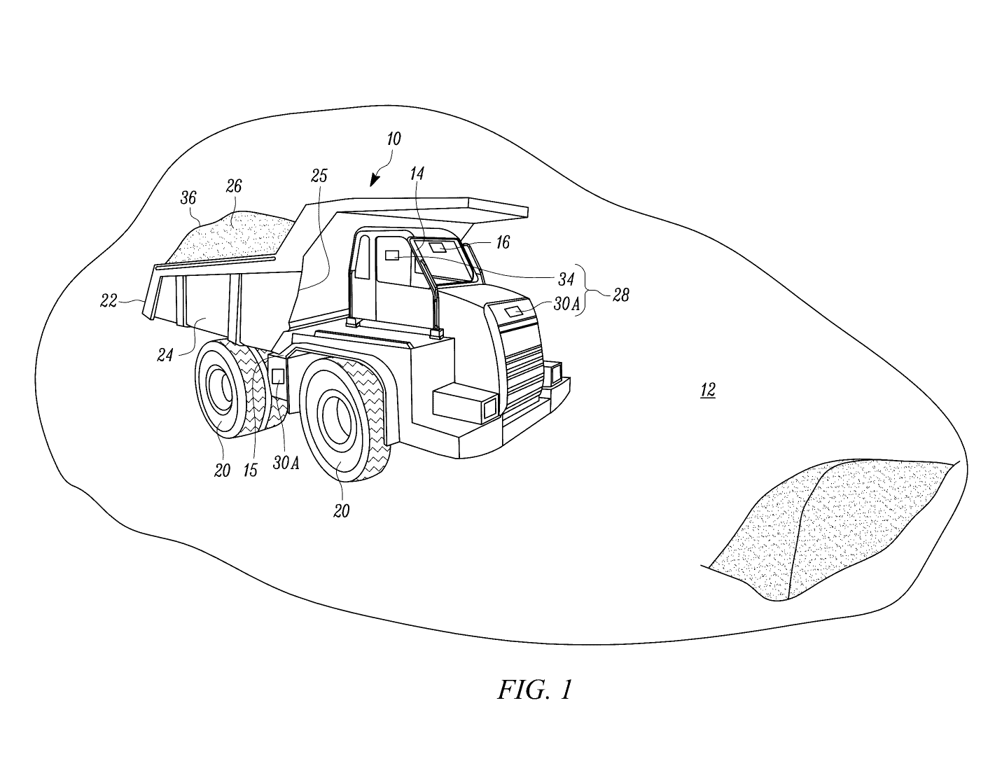

FIG. 1 illustrates a perspective view of a machine 10 disposed at a worksite 12. For the purpose of illustration of the present disclosure, a large mining truck, also known as a haul truck, is embodied as the machine 10. However, it should be understood that the machine 10 may alternatively be any other machine, such as an articulated truck, an off-highway truck, an on-highway truck, a loader, an excavator, a shovel, a wheel tractor scraper or any other machine capable of transporting material from one location to another location without deviating from the scope of the present disclosure. The machine 10 may also be used in various industries including, but not limited to, construction, agriculture, transportation, mining, material handling, and waste management.

The machine 10 includes an operator cabin 14 mounted on a frame 15 of the machine 10. The operator cabin 14 includes control elements, such as joysticks, for controlling operations of the machine 10. The operator cabin 14 also includes a user interface 16 disposed at a location visually accessible by an operator of the machine 10. In case of an automated machine, the user interface 16 may be disposed at a remote location, and may be communicated using wireless communications. The user interface 16 includes a display device, such as Liquid Crystal Display (LCD) screen and a control console, for enabling the operator to interact with multiple control systems, such as hydraulic system, and electric system, of the machine 10. A powertrain including a power source (not shown), such as an engine, is disposed in the machine 10 to supply power for performing the operations of the machine 10. The powertrain further includes a transmission unit (not shown) for transmitting the power from the power source to a set of ground engaging members 20, such as wheels.

The machine 10 further includes a dump body 22 pivotally mounted on the frame 15 of the machine 10. The dump body 22 is constructed to perform a task of transportation of a load 26 from a loading site at the worksite 12 to a dumping site, such as a processing facility or shipping facility within the worksite 12 or a location outside the worksite 12. The load 26 may include, but not limited to, construction material, sand gravel, stones, rocks soil, excavated material, asphalt, coal, and mineral ores. The dump body 22 includes a bed (not shown), a first side wall 24 extending from the bed, a second side wall (not shown) opposite to the first side wall 24 and extending from the bed, and a front wall 25 positioned between the first side wall 24 and the second side wall. In an example, the dump body 22 may be one of, but not limited to, an ejector type, a side dump type, and a bottom dump type.

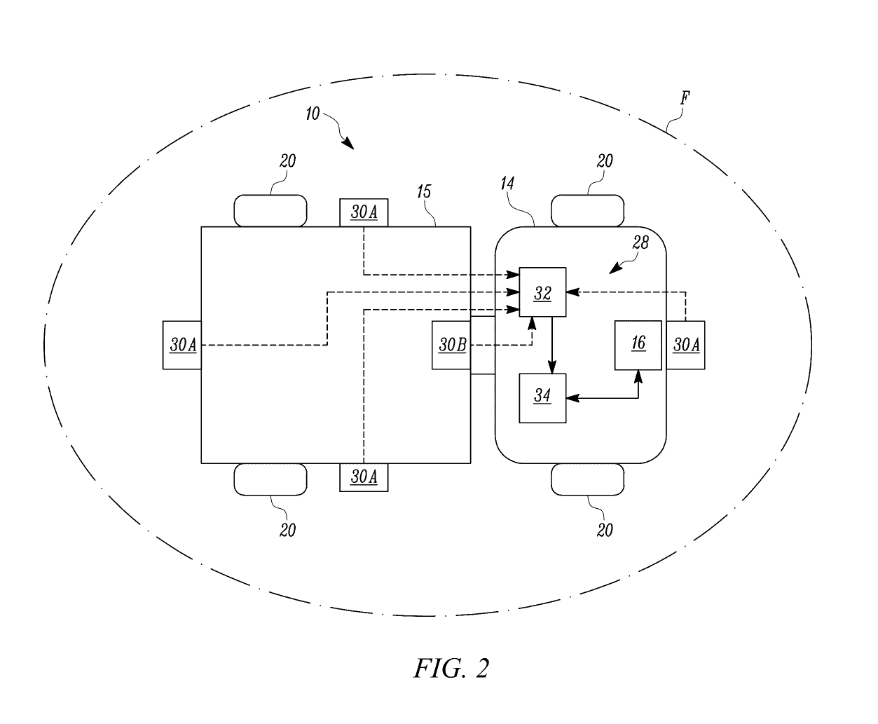

The machine 10 further includes a system 28 for displaying a real time image of the machine 10 to the operator via the user interface 16. Specifically, the system 28 is used for monitoring a loading status of the machine 10, such as the load 26 carried by the dump body 22 of the machine 10. In order to provide the real time image of the dump body 22 and monitor the loading status of the machine 10, the system 28 includes a perception sensor 30, an image processing module 32 (as shown in FIG. 2), and a controller 34. In one example, the system 28 may be disposed on the machine 10. In another example, the system 28 may be disposed at a remote location and maybe communicated using wireless communications. Operational characteristics of the system 28 will be explained in detail herein below with reference to FIG. 2.

Referring to FIG. 2, a block diagram of the system 28 for monitoring the loading status of the machine 10 is illustrated. The system 28 includes the perception sensor 30 coupled to the machine 10. The perception sensor 30 includes a first perception sensor 30A and a second perception sensor 30B. In the present embodiment, the first perception sensor 30A is a surround view camera system. The surround view camera system may include multiple cameras mounted on the frame 15 of the machine 10 to capture images of surrounding of the machine 10. The perception sensor 30 generates signals indicative of an image of the surrounding of the machine 10. The second perception sensor 30B is coupled to the dump body 22 of the machine 10. The second perception sensor 30B is configured to generate signals indicative of an image of the load 26 carried by the dump body 22. A field of view ‘F’ of the perception sensor 30 around the machine 10 varies based on various factors including, but not limited to, range capability of the perception sensor 30 and mounting location of the perception sensor 30 on the machine 10. The perception sensor 30, in another example, may be one of, but not limited to, a Sound Navigation And Ranging (SONAR), a LIght Detection And Ranging (LIDAR), and a radar system without deviating from the scope of the present disclosure.

The perception sensor 30 is communicably coupled to the image processing module 32 disposed in the operator cabin 14. The image processing module 32 receives the signals generated by the perception sensor 30, particularly the second perception sensor 30A and processes the signals to derive point cloud corresponding to a profile 36 (as shown in FIG. 1) of the load 26 carried by the dump body 22 of the machine 10. Specifically, the point cloud is derived based on signals received from the perception sensor 30. The point cloud corresponds to a three dimensional information pertaining to a set of data points defined by X, Y, and Z coordinates along the profile 36 of the load 26 carried by the dump body 22.

The image processing module 32 determines the point cloud corresponding to the profile 36 of the load 26 carried by the dump body 22 based on various factors such as a volume of the load 26 carried by the dump body 22 and weight of the material. The image processing module 32 may determine the various factors of the load 26 carried by the dump body 22 using known data processing algorithms stored in the image processing module 32.

In an example, the image processing module 32 may determine the point cloud corresponding to the profile 36 of the load 26 based on an estimation of the volume of the load 26 carried by the dump body 22. More specifically, the volume of the load 26 carried by the dump body 22 may be correlated with a volume defined by the dump body 22. In one example, the correlation may be a dataset stored in a memory (not shown) of the image processing module 32. The dataset may include multiple values of the volume of the load 26 carried by the dump body 22 and the volume of the dump body 22. In another example, the correlation may be a mathematical expression between the volume of the load 26 carried by the dump body 22 and the volume of the dump body 22.

In another example, the image processing module 32 may determine the point cloud corresponding to the profile 36 of the load 26 based on the weight of the material carried by the dump body 22. The weight of the material carried by the dump body 22 may be determined based on a signal generated by a pressure sensor (not shown) coupled to a hydraulic cylinder (not shown) associated with the dump body 22. More specifically, the weight of the material carried by the dump body 22 may be correlated to the volume of the dump body 22. In one example, the correlation may be a dataset stored in the memory of the image processing module 32. The dataset may include multiple values of the weight of the material carried by the dump body 22 and the volume of the dump body 22. In another example, the correlation may be a mathematical expression between the weight of the material carried by the dump body 22 and the volume of the dump body 22.

Upon determining the point cloud, the image processing module 32 communicates the point cloud with the controller 34 disposed in the operator cabin 14. In one example, the image processing module 32 may be an integral component of the controller 34. In another example, the controller 34 of the system 28 may be an integral component of a machine controller that is used for controlling the various control systems of the machine 10. In an example, the controller 34 may include access memory, secondary storage devices, processors, and any other components for running an application. The memory and secondary storage devices may be in the form of read-only memory (ROM) or random access memory (RAM) or integrated circuitry that is accessible by the controller 34. Various other circuits may be associated with the controller 34, such as power supply circuitry, signal conditioning circuitry, driver circuitry, and other types of circuitry. The controller 34 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine 10. The functionality of the controller 34 may be implemented in hardware and/or software without regard to the functionality.

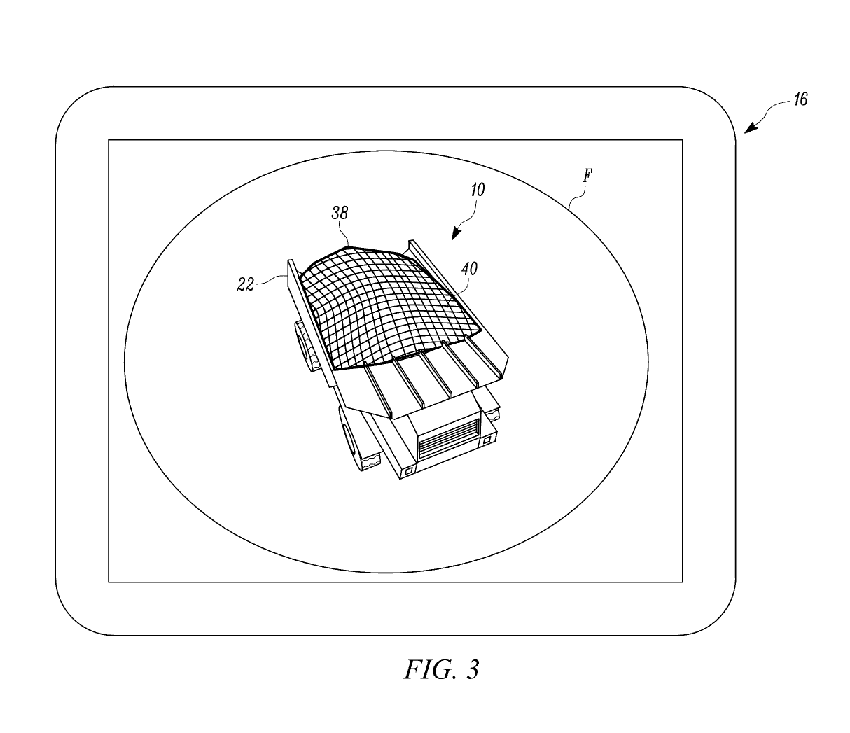

FIG. 3 illustrates a schematic representation of the loading status of the machine 10 as displayed in the user interface 16 of the machine 10. Referring to FIGS. 2 and 3, the controller 34 is communicably coupled to the image processing module 32 and the perception sensor 30. Owing to the coupling, the controller 34 receives the signals indicative of the load 26 carried by the dump body 22 from the perception sensor 30. In addition, the controller 34 receives the point cloud corresponding to the profile 36 of the load 26 carried by the dump body 22 from the image processing module 32.

The controller 34 further generates a three dimensional polygonal layout 38 corresponding to the profile 36 of the load 26 carried by the dump body 22 based on the signals received from the perception sensor 30 and the point cloud. The three dimensional polygonal layout 38 thus formed corresponds to an interlaced structure formed by joining the point cloud. The controller 34 further generates a fill model image 40 using the three dimensional polygonal layout 38. Specifically, the controller 34 overlays a solid image of the profile 36 of the load 26 over the three dimensional polygonal layout 38.

The controller 34 further superimposes the fill model image 40 on a preset image of the dump body 22 of the machine 10, as such a real time image of the load 26 disposed on the dump body 22 of the machine 10 is generated. In one example, the preset image of the machine 10 may be stored in a storage unit (not shown) of the controller 34. The preset image of the machine 10 is generally combined with the surrounding of the machine 10. In other example, the preset image may be a real time image captured by the perception sensor 30. The controller 34 further continuously updates the real time image of the machine 10 during loading and unloading operation of the machine 10 at the worksite 12, and displays the real time image of the machine 10 to the operator via the user interface 16.

### INDUSTRIAL APPLICABILITY

The present disclosure relates to the system 28 and a method 50 for monitoring the loading status of the machine 10 disposed at the worksite 12. The system 28 includes the perception sensor 30, the image processing module 32 and the controller 34 to capture surround view images of the machine 10, and provide real time images of the dump body 22 along with the load carried by the dump body 22 to the operator via the user interface 16.

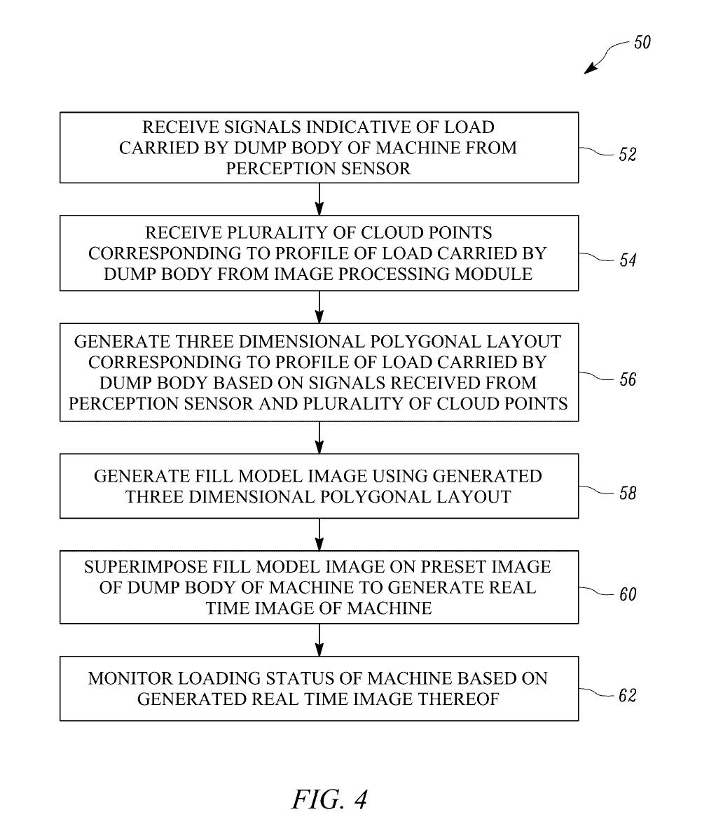

Referring to FIG. 4, the method 50 of monitoring the loading status of the machine 10 disposed at the worksite 12 is illustrated. Steps in which the method 50 is described are not intended to be construed as a limitation, and any number of steps can be combined in any order to implement the method 50. Further, the method 50 may be implemented in any suitable hardware, such that the hardware employed can perform the steps of the method 50 readily and on a real-time basis.

At a block 52, the method 50 includes receiving, by the controller 34, signals indicative of the load 26 carried by the dump body 22 of the machine 10 from the perception sensor 30. The perception sensor 30 generates the signals indicative of the surrounding of the machine 10 and the load 26 carried by the dump body 22. The perception sensor 30 subsequently transmits the signals indicative of the load 26 carried by the dump body 22 to the image processing module 32. The image processing module 32 processes the signals to derive the point cloud corresponding to the profile 36 of the load 26 carried by the dump body 22 based on various factors, such as the volume of the load 26 carried by the dump body 22 and the weight of the material contained in the dump body 22.

At a block 54, the controller 34 receives the point cloud corresponding to the profile 36 of the load 26 carried by the dump body 22 from the image processing module 32. At a block 56, the controller 34 generates the three dimensional polygonal layout 38 based on the signals received from the perception sensor 30 and the point cloud determined by the image processing module 32. The three dimensional polygonal layout 38 thus generated corresponds to the profile 36 of the load 26 carried by the dump body 22.

At a block 58, the controller 34 generates the fill model image 40 using the generated three dimensional polygonal layout 38. Specifically, the controller 34 overlays the solid image of the profile 36 of the load 26 over the three dimensional polygonal layout 38. At a block 60, the controller 34 superimposes the fill model image 40 on the preset image of the machine 10, as such the real time image of the load 26 disposed on the dump body 22 of the machine 10 is generated. At a block 62, the controller 34 continuously updates the real time image of the machine 10 during loading and unloading operations of the machine 10 at the worksite 12, and displays the real time image to the operator via the user interface 16. As such, the system 28 provides real time monitoring of the loading status of the machine 10 based on the generated real time image of the machine 10 for enhanced visibility of the machine at the worksite. The system 28 also provides near real time monitoring of the loading status of the machine 10. In order to provide the near real time monitoring of the loading status, the controller 34 of system 28 periodically receives the point cloud, when the perception sensor 30 detect that a change in load in the dump body 22 is sufficient to update the fill model image 40 on the preset image of the machine 10.

With the present disclosure, operational efficiency of the machine 10 may be improved by taking required action based on the real time image of the load carried by the dump body 22. Also, due to real time indication of the loading status of the dump body 22, machine productivity, machine efficiency, and fuel efficiency may be improved by controlling loading and unloading operation of the machine. Additionally, the system 28 may also be used to reduce training duration and/or effort required for novice operators by providing enhanced visibility of the machine and the dump body 22 with the loading status in the user interface 16.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of monitoring a loading status of a machine disposed at a worksite, the method comprising:
receiving signals indicative of a load carried by a dump body of the machine from a perception sensor;
receiving point cloud corresponding to a profile of the load carried by the dump body from an image processing module, wherein the point cloud are derived based on the signals received from the perception sensor;
generating a three dimensional polygonal layout corresponding to the profile of the load carried by the dump body based on the signals received from the perception sensor and the point cloud;
generating a fill model image using the generated three dimensional polygonal layout;
superimposing the fill model image on a preset image of the dump body of the machine to generate a real time image of the machine; and
monitoring the loading status of the machine based on the generated real time image thereof.
